(19) United States
(12) Patent Application Publication
(10) Pub. No.: US 2005/0134665 A1
(43) Pub. Date: Jun. 23, 2005

(54) Ink jet ink composition

(75) Inventors: Xiaoru Wang, Webster, NY (US); Huijuan D. Chen, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/742,168

(22) Filed: Dec. 19, 2003

(51) Int. Cl. G01D 11/00

(52) U.S. Cl. 347/100

(57) ABSTRACT

An ink jet ink composition comprising an aqueous carrier medium, a surfactant, a pigment and a polymer, wherein the polymer contains benzyl methacrylate and is not associated with the pigment particles.

### FIELD OF THE INVENTION

This invention relates to an aqueous ink jet ink that comprises an aqueous carrier medium, a colorant, and a polymer wherein the polymer contains benzyl methacrylate and is not associated with the pigment particles. The inks nave excellent print quality, image stability, water and smear resistance, scratch resistance and storage stability.

### BACKGROUND OF THE INVENTION

Ink jet printing is a non-impact method for producing images by the deposition of ink droplets on a substrate (paper, transparent film, fabric, etc.) in response to digital signals. Ink jet printers have found broad applications across markets ranging from industrial labeling to short run printing to desktop document and pictorial imaging.

In ink jet recording processes, it is necessary that the inks being used meet various performance requirements. Such performance requirements are generally more stringent than those for other liquid ink applications, such as for writing instruments (e.g., a fountain pen, felt pen, etc.). In particular, the following conditions are generally required for inks utilized in ink jet printing processes:
(1) The ink should possess physical properties such as viscosity, surface tension, and electric conductivity matching the discharging conditions of the printing apparatus, such as the driving voltage and driving frequency of a piezoelectric electric oscillator, the form and material of printhead orifices, the diameter of orifices, etc;
(2) The ink should be capable of being stored for a long period of time without causing clogging of printhead orifices during use;
(3) The ink should be quickly fixable onto recording media, such as paper, film, etc., such that the outlines of the resulting ink dots are smooth and there is minimal blotting of the dotted ink;
(4) The printed image should be of high quality, such as having a clear color tone and high density, have high gloss and high color gamut;
(5) The printed image should exhibit excellent waterfastness (water resistance) and lightfastness (light resistance);
(6) The printed (ink) images should have good adhesion to the surface of image receiving elements and should be durable and highly resistant to physical and mechanical scratches or damages;
(7) The ink should not chemically attack, corrode or erode surrounding materials such as the ink storage container, printhead components, orifices, etc;
(8) The ink should not have an unpleasant odor and should not be toxic or inflammable; and
(9) The ink should exhibit low foaming and high pH stability characteristics.

The inks used in various ink jet printers can be classified as either dye-based or pigment-based. A dye is a colorant which is molecularly dispersed or solvated by a carrier medium. The carrier medium can be a liquid or a solid at room temperature. A commonly used carrier medium is water or a mixture of water and organic cosolvents. Each individual dye molecule is surrounded by molecules of the carrier medium. In dye-based inks, no particles are observable under the microscope. Although there have been many recent advances in the art of dye-based ink jet inks, such inks still suffer from deficiencies such as low optical densities on plain paper and poor lightfastness. When water is used as the carrier medium, such inks also generally suffer from poor waterfastness.

Pigment-based inks have been gaining in popularity as a means of addressing these limitations. In pigment-based inks, the colorant exists as discrete particles. These pigment particles are usually treated with addenda known as dispersants or stabilizers which serve to keep the pigment particles from agglomerating and/or settling out.

Pigment-based inks suffer from a different set of deficiencies than dye-based inks. One deficiency is that pigment-based inks interact differently with specially coated papers and films, such as transparent films used for overhead projection and glossy papers and opaque white films used for high quality graphics and pictorial output. In particular, it has been observed that pigment-based inks produce imaged areas that are entirely on the surface of coated papers and films which results in images that have poor dry and wet adhesion properties and can be easily smudged. In recent years, ink jet receivers have been developed to have both high gloss and high porosity to give fast drying capabilities. However, scratch mark smudges are more visible on high gloss receivers. There is a need to provide a pigmented ink composition that results in images on the surface of an ink jet receiving element which have improved durability and smudging resistance.

Ozone is generally present in the air at sea level at concentration of about 10 to 50 parts per billion. Only under certain conditions does the ozone concentration exceed these levels. However, even at the low ozone concentrations, dyes and pigments such as ink jet dyes and pigments can be very sensitive and fade significantly when the air permeability is high, such as when they are printed onto porous, glossy receivers.

Although ink jet receivers designed for outdoor usage tend to have good durability when printed with pigmented inks, they also fade significantly due to their exposure to ozone caused by high air permeability.

U.S. Pat. No. 5,716,436 and JP 2000-290553 disclose the use of water-dispersible polymers in ink jet inks printed onto plain paper. However, images printed with these inks have low optical densities and very poor wet abrasion resistance and will not withstand outdoor applications.

U.S. Pat. No. 6,087,416 discloses a polymeric dispersant and optionally a graft copolymer added for use on vinyl substrates. The polymeric dispersant is associated with the pigment. The process disclosed for making the polymer and the polymeric dispersant is very expensive, difficult and time consuming. Also, in the case of adding grafted polymers, an extra polymer is used. The disadvantage is that when too much polymer is used in inks, the jetting property of the inks is poor, especially for thermal ink jet printer heads.

It is an object of the present invention to overcome the disadvantages of the prior art, so that images printed with the inventive ink composition will have improved ozonefastness, physical durability such as scratch and smudging resistance. It is also an object of the invention that the inks can also be used for outdoor applications.

### SUMMARY OF THE INVENTION

This invention provides an ink jet ink composition comprising an aqueous carrier medium, a surfactant, a pigment and a polymer, wherein the polymer contains benzyl methacrylate and is not associated with the pigment particles.

As used herein the term “not associated with” means the polymer was used as an additive, and was not milled with the pigment or encapsulated with the pigment. The polymer is generally considered to be a binder.

The invention overcomes the difficulties and high cost incurred by the prior art processes in making the polymer, in making the pigment dispersion, and in preparing the ink. The ink provides images that have improved ozonefastness, physical durability such as scratch and smudging resistance, and outdoor durability.

### DETAILED DESCRIPTION OF THE INVENTION

The support for the ink-receiving element employed in the invention can be paper or resin-coated paper, or plastics such as a polyester-type resin such as poly(ethylene terephthalate), polycarbonate resins, polysulfone resins, methacrylic resins, cellophane, acetate plastics, cellulose diacetate, cellulose triacetate, vinyl chloride resins, poly(ethylene naphthalate), polyester diacetate, various glass materials, etc. The thickness of the support employed in the invention can be from 12 to 500 μm, preferably from 75 to 300 μm.

In a preferred embodiment the ink receiving layer is a continuous, coextensive, porous ink-receiving layer contains inorganic particles such as silica, alumina, titanium dioxide, clay, calcium carbonate, barium sulfate, or zinc oxide. In another preferred embodiment, the porous ink-receiving layer comprises from about 20% to about 95% inorganic particles and from about 5% to about 80% polymeric binder, such as gelatin, poly(vinyl alcohol), poly(vinyl pyrrolidinone) or poly(vinyl acetate) and copolymers thereof. The porous ink-receiving layer can also contain polymer micro-porous structures without inorganic filler particles as shown in U.S. Pat. Nos. 5,374,475 and 4,954,395.

A wide variety of organic and inorganic pigments, alone or in combination, may be selected for use in the present invention. Useful pigments include those disclosed, for example, in U.S. Pat. Nos. 5,026,427; 5,086,698; 5,141,556; 5,160,370; and 5,169,436. The exact choice of pigments will depend upon the specific application and performance requirements such as color reproduction and image stability. Pigments suitable for use in the present invention include, for example, azo pigments, monoazo pigments, disazo pigments, azo pigment lakes, P-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black. Typical examples of pigments which may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Violet 1, 2, 3, 5:1, 13, 19, 23, 25, 27, 29, 31, 32, 37, 39, 42, 44, 50; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66; C.I. Pigment Green 1, 2, 4, 7, 8, 10, 36, 45; C.I. Pigment Black 1, 7, 20, 31, 32, and C.I. Pigment Brown 1, 5, 22, 23, 25, 38, 41, 42. In a preferred embodiment of the invention, the pigment is C.I. Pigment Blue 15:3, C.I. Pigment Red 122, C.I. Pigment Yellow 155, C.I. Pigment Yellow 74, bis(phthalocyanylalumino)tetraphenyldisiloxane or C.I. Pigment Black 7.

The aqueous carrier medium for the ink composition is water or a mixture of water and at least one water miscible co-solvent. Selection of a suitable mixture depends on requirements of the specific application, such as desired surface tension and viscosity, the selected pigment, drying time of the pigmented ink jet ink, and the type of paper onto which the ink will be printed. Representative examples of water-miscible co-solvents that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, tetraethylene glycol, propylene glycol, polyethylene glycol, glycerol, 2-methyl-2,4-pentanediol 1,2,6-hexanetriol and thioglycol; (6) lower alkyl mono- or di-ethers derived from alkylene glycols, such as ethylene glycol mono-methyl (or -ethyl) ether, diethylene glycol mono-methyl (or -ethyl) ether, diethylene glycol mono-butyl (or -ethyl) ether, propylene glycol mono-methyl (or -ethyl) ether, poly(ethylene glycol) butyl ether, triethylene glycol mono-methyl (or -ethyl) ether and diethylene glycol di-methyl (or -ethyl) ether; (7) nitrogen containing cyclic compounds, such as pyrrolidone, N-methyl-2-pyrrolidone, and 1,3-dimethyl-2-imidazolidinone; and (8) sulfur-containing compounds such as dimethyl sulfoxide, 2,2′-thiodiethanol, and tetramethylene sulfone.

In general it is desirable to make the pigmented ink jet ink in the form of a concentrated mill grind, which is subsequently diluted to the appropriate concentration for use in the ink jet printing system. This technique permits preparation of a greater quantity of pigmented ink from the equipment. If the mill grind is made in a solvent, it is diluted with water and optionally other solvents to the appropriate concentration. If it is made in water, it is diluted with either additional water or water miscible solvents to the desired concentration. By dilution, the ink is adjusted to the desired viscosity, color, hue, saturation density, and print area coverage for the particular application. The method for the preparation of the mill grind is disclosed in U.S. Pat. Nos. 5,679,138; 5,670,139 and 6,152,999.

In the case of organic pigments, the ink may contain up to approximately 30% pigment by weight, but will generally be in the range of approximately 0.1 to 10%, preferably approximately 0.1 to 5%, by weight of the total ink composition for most ink jet printing applications. If an inorganic pigment is selected, the ink will tend to contain higher weight percentages of pigment than with comparable inks employing organic pigments, and may be as high as approximately 75% in some cases, since inorganic pigments generally have higher specific gravities than organic pigments.

The amount of aqueous carrier medium is in the range of approximately 70 to 99 weight %, preferably approximately 90 to 98 weight %, based on the total weight of the ink. A mixture of water and a polyhydric alcohol, such as diethylene glycol, is useful as the aqueous carrier medium. In a preferred embodiment, the inks contain from 5 to 60 weight % of water miscible organic solvent. Percentages are based on the total weight of the aqueous carrier medium.

The polymer used in this invention is generally a copolymer with both hydrophobic and hydrophilic units and a benzyl methacrylate monomer. The benzyl methacrylate monomer is generally contained in the hydrophobic segment. The hydrophobic segment of the polymer may comprise one or more than one monomer type. It is preferred that the polymer has a number average molecular weight of 2,000 to 500,000, and more preferably of 5,000 to 100,000.

Benzyl methacrylate is generally 1% to 95% by weight based on the total weight of the polymer. More preferably, benzyl methacrylate is 40% to 80% by weight of the total polymer. The hydrophobic segment may comprise only benzyl methacrylate or the hydrophobic segment may be formed from the polymerization of benzyl methacrylate and at least one other vinyl-type monomer. The vinyl-type monomers include, for example, allyl compounds, vinyl ethers, vinyl heterocyclic compounds, styrenes, olefins and halogenated olefins, ethylenically unsaturated carboxylic acids and esters derived from them, unsaturated nitriles, vinyl alcohols, acrylamides and methacrylamides, vinyl ketones, multifunctional monomers, or copolymers formed from various combinations of these monomers. Hydrophilic polymers can be selected from acrylic acid, methacrylic acid, acrylimide, ethacrylic acid, acrylamide, methacrylamide, N,N-dimethyl acrylamide, N-methyl acrylamide, N-methyl methacrylamide, aryloxy dimethyl acrylamide, N-methyl acrylamide, N-methyl methacrylamide, aryloxy piperidine, and N,N-dimethyl acrylamide acrylic acid, methacrylic acid, chloromethacrylic acid, maleic acid, allylamine, N,N-diethylallylamine, vinyl sulfonamide, sodium acrylate, sodium methacrylate, ammonium acrylate, ammonium methacrylate, acrylamidopropanetriethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium styrenesulfonate, sodium acrylamidopropanesulfonate, sodium methacrylamidopropanesulfonate, and sodium vinyl morpholine sulfonate, allyl methacrylate, allyl acrylate, butenyl acrylate, undecenyl acrylate, undecenyl methacrylate, vinyl acrylate, and vinyl methacrylate; dienes such as butadiene and isoprene; esters of saturated glycols or diols with unsaturated monocarboxylic acids such as, ethylene glycol diacrylate, ethylene glycol dimethacrylate, triethylene glycol dimethacrylate, 1,4-butanediol dimethacrylate, 1,3-butanediol dimethacrylate, pentaerythritol tetraacrylate, or trimethylol propane trimethacrylate.

For example, the monomer for the styrene/acrylic polymer may be formed from methyl acrylate, ethyl acrylate, ethyl methacrylate, benzyl acrylate, benzyl methacrylate, propyl acrylate, propyl methacrylate, iso-propyl acrylate, isopropyl methacrylate, butyl acrylate, butyl methacrylate, hexyl acrylate, hexyl methacrylate, octadecyl methacrylate, octadecyl acrylate, lauryl methacrylate, lauryl acrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, phenethylacrylate, phenethyl methacrylate, 6-phenylhexyl acrylate, 6-phenylhexyl methacrylate, phenyllauryl acrylate, phenyllaurylmethacrylate, 3-nitrophenyl-6-hexyl methacrylate, 3-nitrophenyl-18-octadecyl acrylate, ethyleneglycol dicyclopentyl ether acrylate, vinyl ethyl ketone, vinyl propyl ketone, vinyl hexyl ketone, vinyl octyl ketone, vinyl butyl ketone, cyclohexyl acrylate, 3-methacryloxypropyl-dimethylmethoxysilane, 3-methacryloxypropyl-methyldimethoxysilane, 3-methacryloxypropyl-pentamethyldisiloxane, 3-methacryloxypropyltris-(trimethylsiloxy)silane, 3-acryloxypropyl-dimethylmethoxysilane, acryloxypropylmethyldimethoxysilane, trifluoromethyl styrene, trifluoromethyl acrylate, trifluoromethyl methacrylate, tetrafluoropropyl acrylate, tetrafluoropropyl methacrylate, heptafluorobutyl methacrylate, isobutyl acrylate, isobutyl methacrylate, 2-ethylhexyl acrylate, 2-ethylhexyl methacrylate, isooctyl acrylate, isooctyl methacrylate, N,N-dihexyl acrylamide, N,N-dioctyl acrylamide, N,N-dimethylaminoethyl acrylate, N,N-dimethylaminoethyl methacrylate, N,N-diethylaminoethyl acrylate, N,N-diethylaminoethyl methacrylate, piperidino-N-ethyl acrylate, vinyl propionate, vinyl acetate, vinyl butyrate, vinyl butyl ether, and vinyl propyl ether ethylene, styrene, vinyl carbazole, vinyl naphthalene, vinyl anthracene, vinyl pyrene, methyl methacrylate, methyl acrylate, alpha-methylstyrene, dimethylstyrene, methylstyrene, vinylbiphenyl, glycidyl acrylate, glycidyl methacrylate, glycidyl propylene, 2-methyl-2-vinyl oxirane, vinyl pyridine, aminoethyl methacrylate, aminoethylphenyl acrylate, maleimide, N-phenyl maleimide, N-hexyl maleimide, N-vinyl-phthalimide, and N-vinyl maleimide poly(ethylene glycol) methyl ether acrylate, polyvinyl alcohol, vinyl pyrrolidone, vinyl 4-methylpyrrolidone, vinyl 4-phenylpyrrolidone, vinyl imidazole, vinyl 4-methylimidazole, vinyl 4-phenylimidazole, methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, benzyl methacrylate, 2-hydroxypropyl methacrylate, acrylonitrile, methacrylonitrile, vinyl acetate, vinyl propionate, vinylidene chloride, vinyl chloride, styrene, t-butyl styrene, vinyl toluene, butadiene, isoprene, N,N-dimethyl acrylamide, acrylic acid, methacrylic acid, chloromethacrylic acid, maleic acid, allylamine, N,N-diethylallylamine, vinyl sulfonamide, sodium acrylate, sodium methacrylate, ammonium acrylate, ammonium methacrylate, acrylamidopropane-triethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium 2-acrylamido-2-methyl-1-propanesulfonate or sodium styrenesulfonate.

Depending on the types of initiators used, the reaction temperature can vary from about 30° C. to about 200° C. Preferably the reaction temperature is at least 40° C., and most preferably at least 50° C. To ensure that no free monomer is present, usually the reaction is continued for a time after the monomer addition. Also, more initiator may need to be added as a scavenger during the final stage of the reaction to increase the reaction conversion.

Addition polymerization initiators useful in the practice of the invention include, for example, azo and diazo compounds, such as 2,2′-azobisisobutyronitrile, 2,2′-azobis(2,4-dimethyl valeronitrile), 2,2′-azobis(2,3-dimethyl butyronitrile), 2,2′-azobis(2-methyl butyronitrile), 2,2′-azobis(2,3,3-trimethyl butyronitrile), 2,2′-azobis(2-isopropyl butyronitrile), 1,1′-azobis(cyclohexane-1-carbonitrile), 2,2′-azobis(4-methoxyl-2,4-dimethyl valeronitrile), 2-(carbamoylazo)isobutyronitrile, 4,4′-azobis(4-cyanovaleric acid), and dimethyl -2,2′azobis isobutyrate, or peroxide compounds, such as butyl peroxide, propyl peroxide, butyryl peroxide, benzoyl isobutyryl peroxide, and benzoyl peroxide, or water soluble initiators, for example, sodium persulfate, and potassium persulfate, or any redox initiators. Preferred initiators are the oil soluble initiators. Examples of particularly suitable initiators are azo, peroxide, persulfate, and redox initiators. The initiators may be used in an amount varying from 0.2 to 4 weight percent or higher by weight of the total monomers. A chain transfer agent such as butyl mercaptan, may also be used to control the properties of the polymer formed.

The polymers can be made via solution, or bulk polymerization and then post-emulsification. The polymer employed in the invention in general has a Tg of —50 to 150° C., preferably 5 to 100° C.

The polymer used in the invention is present in the ink jet ink generally from 0.1% to 20% by weight, preferably from 0.5% to 5% by weight.

It has been observed that, in general, the addition of polymer in inks can be used to increase the gloss level of the receiver surface in the printed areas after the inks have being printed onto it.

Jet velocity, separation length of the droplets, drop size and stream stability are greatly affected by the surface tension and the viscosity of the ink. Pigmented ink jet inks suitable for use with ink jet printing systems should have a surface tension in the range of 20 dynes/cm to 60 dynes/cm and, more preferably, in the range 20 dynes/cm to 50 dynes/cm. Control of surface tensions in aqueous inks is accomplished by additions of small amounts of surfactants. The level of surfactants to be used can be determined through simple trial and error experiments. Anionic and cationic surfactants may be selected from known in the ink jet ink art. Commercial surfactants include the Surfynols® from Air Products; the Zonyls® from DuPont and the Fluorads® from 3M.

A humectant is added to the composition employed in the process to help prevent the ink from drying out or crusting in the orifices of the ink jet printhead. Polyhydric alcohols useful in the composition employed in the invention for this purpose include, for example, ethylene glycol, diethylene glycol, triethylene glycol, propylene glycol, tetraethylene glycol, polyethylene glycol, glycerol, 2-methyl-2,4-pentanediol, 1,2,6-hexanetriol and thioglycol. The humectant may be employed in a concentration of from 10 to 50% by weight. In a preferred embodiment, diethylene glycol or a mixture of glycerol and diethylene glycol is employed a concentration of between 10 and 20% by weight.

The ink has physical properties compatible with a wide range of ejecting conditions, i.e., driving voltages and pulse widths for thermal ink jet printing devices, driving frequencies of the piezo element for either a drop-on-demand device or a continuous device, and the shape and size of the nozzle.

A penetrant (0-10% by weight) may also be added to the ink composition employed in the process of the invention to help the ink penetrate the receiving substrate, especially when the substrate is a highly sized paper. A preferred penetrant for the inks employed in the present invention is n-propanol at a final concentration of 1-6% by weight.

A biocide (0.01-1.0% by weight) may also be added to prevent unwanted microbial growth which may occur in the ink over time. A preferred biocide for the inks employed in the present invention is Proxel® GXL (Zeneca Colours Co.) at a concentration of 0.05-0.5% by weight. Additional additives which may optionally be present in ink jet inks include thickeners, conductivity enhancing agents, anti-kogation agents, drying agents, and defoamers.

Ink jet inks made using polymers employed in this invention are employed in ink jet printing wherein liquid ink drops are applied in a controlled fashion to an ink receiving substrate, by ejecting ink droplets from plurality of nozzles, or orifices, in a print head of ink jet printers.

Commercially available ink jet printers use several different methods to control the deposition of the ink droplets. Such methods are generally of two types: continuous stream and drop-on-demand.

In drop-on-demand systems, a droplet of ink is ejected from an orifice directly to a position on the ink receiving layer by pressure created by, for example, a piezoelectric device, an acoustic device or a thermal process controlled in accordance digital data signals. An ink droplet is not generated and ejected through the orifices of the print head unless it is needed. Ink jet printing methods, and related printers, are commercially available and need not be described in detail.

The ink composition of the present invention is suited for printing on a variety of substrates, including porous and non-porous surfaces. Porous inkjet receivers have the advantage of large fluid intake and this provides fast printing speed. The non-absorbing substrates that may be used in the present invention include any substrate that is essentially non-porous. They are usually not specially treated for additional liquid absorption. Therefore, these materials have very low or no liquid absorbing capacity. Examples of such non-absorbing substrates are metals such as aluminum, copper, stainless steel and alloy etc.; plastics such as vinyl, polycarbonate, polytetrafluoroethylene (PTFE), polyethylene, polypropylene, polystyrene, cellulose; and other substrates such as ceramics, glass. To accelerate the printing speed and increase durability, an extra heating step can be added during the process of printing the ink composition of this invention. This heating step can be employed either during printing or after printing. Various methods may be used for the means of heating, for example, using light irradiation, a hot air source or an electrical heater. For the heating step during printing, an electrical heater or an infrared lamp is preferred. For the heating step after printing, light irradiation such as an infrared lamp is preferred. Optionally, an infrared absorbing material can be employed in the ink of the present invention to assist the heating by an infrared lamp.

The following examples illustrate the utility of the present invention.

### EXAMPLES

Preparation of Pigment Dispersion

The magenta pigment dispersion contains: 300 g of Polymeric beads, mean diameter of 50 μm (milling media); 30 g of quinacridone magenta pigment Pigment Red 122 (Sun Chemicals); 9 g of Oleoyl methyl taurine, (OMT) Potassium salt and 208 g of Deionized water, and 0.2 g of Proxel GXL® (biocide from Zeneca). The above components were milled in a 2 liter double walled vessel obtained from BYK-Gardner using a high energy media mill manufactured by Morehouse-Cowles Hochmeyer. The mill was run for approximately 8 hours at room temperature. The dispersion was separated from the milling media by filtering the millgrind through a 4-8 μm KIMAX® Buchner Funnel obtained from VWR Scientific Products. At the end of milling, additional water is added to the dispersion so that the pigment is about 10.0% by weight of the total final dispersion and the biocide is about 230 ppm by weight of the total final dispersion. The particle size is about 30 nm as measured by MICROTRAC II Ultrafine particle analyzer (UPA) manufactured by Leeds & Northrup.

Preparation of Polymers

Inventive Polymer 1 (P-1)

100 g of diethylene glycol and 0.25 g of AIBN were charged to a 1-liter, three-neck round-bottom flask equipped with a mechanical stirrer and nitrogen inlet. The solution was purged with nitrogen for 20 min and heated to 150C in a constant temperature bath. 100 g of diethylene glycol, 0.25 g of AIBN, 32.5 g of benzyl methacrylate, and 17.5 g of methacrylic acid were stirred and mixed well. Then the mixture was funneled into the reactor and left there for over 2 hours. Polymerization was continued for 3 hours. The temperature was reduced to 65-70 C and 1 ml each of t-butyl hydroperoxide (10%) and sodium formaldehyde bisulfite (10%) were post-added.

The final solution was neutralized with ammounium hydroxide, diluted with appropriate amount of water such that it contains ˜20% polymer and 10% diethylene glycol.

Inventive Polymer 2(P-2)

100 g of diethylene glycol and 0.20 g of AIBN were charged to a 1-liter, three-neck round-bottom flask equipped with a mechanical stirrer and nitrogen inlet. The solution was purged with nitrogen for 20 min and heated to 150C in a constant temperature bath. 100 g of diethylene glycol, 0.20 g of AIBN, 32.5 g of benzyl methacrylate, and 17.5 g of methacrylic acid were stirred and mixed well. Then the mixture was funneled into the reactor over 2 hours. Polymerization was continued for 3 hours. The temperature was reduced to 65-70° C. and 1 ml each of t-butyl hydroperoxide (10%) and sodium formaldehyde bisulfite (10%) were post-added. The final solution was neutralized with ammounium hydroxide, diluted with appropriate amount of water such that it contains 20% polymer and 10% diethylene glycol.

Solution Polymer (P-3)

100 g of diethylene glycol and 0.10 g of AIBN were charged to a 1-liter, three-neck round-bottom flask equipped with a mechanical stirrer and nitrogen inlet. The solution was purged with nitrogen for 20 min and heated to 150C in a constant temperature bath. 100 g of diethylene glycol, 0.10 g of AIBN, 32.5 g of benzyl methacrylate, and 17.5 g of methacrylic acid were stirred and mixed well. Then the mixture was funneled into the reactor over 2 hours. Polymerization was continued for 3 hours. The temperature was reduced to 65-70° C. and 1 ml each of t-butyl hydroperoxide (10%) and sodium formaldehyde bisulfite (10%) were post-added. The final solution was neutralized with ammounium hydroxide, diluted with appropriate amount of water such that it contains ˜20% polymer and 10% diethylene glycol.

Polymer Characterization

Number Average Molecular Weight:

The samples were analyzed by size-exclusion chromatography (SEC) in tetrahydrofuran using three Polymer Laboratories Plgel® mini-mixed-B columns. The column set was calibrated with narrow molecular weight distribution polystyrene standards between 580 and 2,300,000.

P-1 has a number average molecular weight of 4,868, P-2 has a number average molecular weight of 8280, P-3 has a number average molecular weight of 11, 260.

Preparation of Comparative Polymer 1 (PC-1: Acrylic Polymer Containing No-Benzyl Methacrylate Unit)

25 g of styrene acrylic polymer Trudot IJ-4655® (from Westvaco), was added in 67.8 g of water, and 7.2 g 29% ammonium hydroxide solution. The mixture was stirred at room temperature for 2 hours, and further mixed on a roller mill for 24 hours until clear. The final polymer solution contained 25% polymer Trudot IJ-4655®, with pH 8.97 and is designated as Comparative Polymer 1 (PC-1).

Preparation of Comparative Polymer 2 (PC-2: Acrylic Polymer Containing No Benzyl Methacrylate Unit)

Water soluble polymer Joncryl70® was obtained from Johnson Polymers as a styrene acrylic polymer solution at 30% Solids (neutralized with ammonia). This polymer solution is designated as Comparative Polymer 2 (PC-2).

Ink Formulation

Ink 1 of the Invention (1-1: Ink Containing Polymer P-1)

To prepare the Ink-1, 4.36 g of the Magenta Pigment Dispersion (10% active), 0.1 g Zonyl-FSO (DuPont Corp.), 2.0 g diethylene glycol, 2.0 g 2-pyrrolidone, and 2.18 g of Polymer 1 (20% active) were added together with distilled water so that the final weight of the ink was 20.0 g. The final ink contained 2.18% Pigment Red 122, 0.5% Zonyl-FSO, 10.0% diethylene glycol, 10% pyrrolidone and 2.18% polymer P-1. The solution was filtered through a 1 μm polytetrafluoroethylene filter. Polymer P-1 was used in the ink as a binder, not as a pigment dispersant, therefore it is not closely associated with the pigment particles but is present as an added component in the ink formulation step.

Ink 2 of the Invention (1-2: Ink Containing Polymer P-2)

Ink-2 of the present invention was prepared similar to Ink-1 except that the amount of Polymer 2 (20% active) and the final ink contained 2.18% polymer 2 by weight of the total ink.

Ink 3 of the Invention (1-3: Ink Containing Polymer P-3)

Ink-3 of the present invention was prepared similar to Ink-1 except that the amount of Polymer 3 (20% active) and the final ink contained 2.18% polymer 3 by weight of the total ink.

Comparative Ink 1 (C-1)

The comparative ink 1 was prepared similar to Ink-1 of the Invention except that 2.18 g of water was used instead of Polymer P—I. The final Ink contained no polymers.

Comparative Ink 2 (C-2: Ink Containing Polymer PC—I as a Binder)

The comparative ink 2 was prepared similar to Ink-1 of the Invention except that 1.74 g of Comparative Polymer PC—I (25% active) was used instead of Polymer P-1. The final Ink contained 2.18% of Comparative Polymer PC-1.

Comparative Ink 3 (C-3: Ink Containing Polymer PC-2 as a Binder)

The comparative ink 2 was prepared similar to Ink-1 of the Invention except that 1.45 g of Comparative Polymer PC-2 (30% active) was used instead of Polymer P-1. The final Ink contained 2.18% of Comparative Polymer PC-2.

Printing Test

The Inks of the present invention were filled into ENCAD pigment cartridges and printing was done with an ENCAD VinylJet 36 wide format thermal inkjet printer, using the above inks. Printing samples were prepared using test images consisting of patches with 100% dot coverage, approximately 25 by 25 mm in size, printed onto a commercially available non-absorbing vinyl substrate, a multi-purpose inkjet cast vinyl (Cat No Calon II 4500G Whilte film from Arlon Inc.), using the ENCAD Vinyljet 36 recommended settings to use platen heat ˜65C during printing and an IR lamp heat setting of 65%.

Durability Test

Dry Rub Resistance Test

The dry rub resistance test was carried out by rubbing the samples with a dry Q-tip for 4 passes under a consistent pressure in the 100% dot coverage area of the printed sample. The color loss in the treated sample area and the color transfer to Q-tip were examined visually and a rating of the dry rub resistance was given as follows on a scale of 0 to 5.
0: Best, No color loss, and/or color transfer;
1: hardly visible amount of color loss and/or color transfer;
2: visible amount of color loss and/or color transfer;
3: some color loss and color transfer;
4: large amount of color loss and color transfer;
5. Worst, almost complete color loss and color transfer.
   Wet Rub Resistance Test:

A wet rub resistance test was carried out by placing an approximately 2.54 cm diameter water droplet on the printed samples area with 100% dot coverage for 5 minutes, after which the excess water was wiped off with a paper towel. The above treated area was then rubbed with a dry paper towel for 4 passes under a consistent pressure a 3.5 cm diameter area. The color loss in the treated sample area and the color transfer to the paper towel were examined visually and a rating of the wet rub resistance was given similar as above on a scale of 0 to 5, 0 being the best and 5 being the worst. Both of the dry and wet rub resistance test results are shown in Table 1.

TABLE 1

| | | Dry Rub | Wet Rub |
|---|---|---|---|
| Ink | Polymer | Rating | Rating |
| C-1 | | 5 | 5 |
| C-2 | PC-1 | 4 | 3 |
| C-3 | PC-2 | 3 | 3 |
| I-1 | P-1 | 1 | 2 |
| I-2 | P-2 | 1 | 1 |
| I-3 | P-3 | 0 | 1 |

From the above table, it is evident that the presence of polymer binder in the ink significantly improves the image durability under both dry and wet conditions compared to the inks without polymer binder. The inks of the present invention with benzyl methacrylate containing polymers show further advantages in image durability compared to the comparative inks without benzyl methacrylate containing polymers.

The invention has been described in detail with particular reference to certain preferred embodiments thereof, but it will be understood that variations and modifications can be effected within the spirit and scope of the invention.

1. An ink jet ink composition comprising an aqueous carrier medium, a surfactant, a pigment and a polymer, wherein the polymer contains benzyl methacrylate and is not associated with the pigment particles.

2. The composition of claim 1 wherein the polymer comprises a hydrophobic segment and a hydrophilic segment, wherein said hydrophobic segment comprises said benzyl methacrylate.

3. The composition of claim 2 wherein the hydrophobic segment of the polymer comprises one or more than one monomer type.

4. The composition of claim 1 wherein the pigment is dispersed with a small molecule surfactant, or is dispersed with a polymeric dispersant.

5. The composition of claim 1 wherein benzyl methacrylate is from 1% to 95% by weight of the total polymer.

6. The composition of claim 1 wherein benzyl methacrylate is from 40% to 80% by weight of the total polymer.

7. The composition of claim 1 wherein the polymer is dispersible in water or in an aqueous ink carrier medium.

8. The composition of claim 1 wherein the polymer is soluble in water or in an aqueous ink carrier medium.

9. The composition of claim 1 wherein the polymer has a number average molecular weight of 2,000 to 500,000.

10. The composition of claim 1 wherein the polymer has a number average molecular weight of 5,000 to 100,000.

11. The composition of claim 1 wherein the polymer comprises from 0.1% to 20% by weight of the ink composition.

12. The composition of claim 1 wherein the polymer comprises from about 0.5% to about 5% by weight of the ink composition.

13. The composition of claim 1 wherein the pigment is C.I. Pigment Blue 15:3, C.I. Pigment Red 122, C.I. Pigment Yellow 155, C.I. Pigment Yellow 74, bis(phthalocyanylalumino)tetraphenyldisiloxane, C. I. Pigment Yellow 97 or C.I. Pigment Black 7.

14. The composition of claim 1 wherein the pigment is ≦30 weight percent, based on the weight of the ink composition.

15. The composition of claim 1 wherein the pigment is from 0.1 and 10 weight percent, based on the weight of the ink composition.

16. The composition of claim 2 wherein the hydrophobic segment comprises only benzyl methacrylate.

17. The composition of claim 2 wherein the hydrophobic segment is formed from the polymerization of benzyl methacrylate and at least one other vinyl-type monomer.

18. The composition of claim 17 wherein the vinyl-type monomers include allyl compounds, vinyl ethers, vinyl heterocyclic compounds, styrenes, olefins and halogenated olefins, ethylenically unsaturated carboxylic acids and esters derived from them, unsaturated nitrites, vinyl alcohols, acrylamides and methacrylamides, vinyl ketones, multifunctional monomers, and copolymers formed therefrom.

19. The composition of claim 2 wherein the hydrophillic segment contains monomers that include acrylic acid, methacrylic acid, acrylimide, ethacrylic acid, acrylamide, methacrylamide, N,N-dimethyl acrylamide, N-methyl acrylamide, N-methyl methacrylamide, aryloxy dimethyl acrylamide, N-methyl acrylamide, N-methyl methacrylamide, aryloxy piperidine, and N,N-dimethyl acrylamide acrylic acid, methacrylic acid, chloromethacrylic acid, maleic acid, allylamine, N,N-diethylallylamine, vinyl sulfonamide, sodium acrylate, sodium methacrylate, ammonium acrylate, ammonium methacrylate, acrylamidopropanetriethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium styrenesulfonate, sodium acrylamidopropanesulfonate, sodium methacrylamidopropanesulfonate, and sodium vinyl morpholine sulfonate, allyl methacrylate, allyl acrylate, butenyl acrylate, undecenyl acrylate, undecenyl methacrylate, vinyl acrylate, and vinyl methacrylate; dienes such as butadiene and isoprene; esters of saturated glycols or diols with unsaturated monocarboxylic acids such as, ethylene glycol diacrylate, ethylene glycol dimethacrylate, triethylene glycol dimethacrylate, 1,4-butanediol dimethacrylate, 1,3-butanediol dimethacrylate, pentaerythritol tetraacrylate, or trimethylol propane trimethacrylate.

20. An ink jet printing method comprising the steps of:
A) providing an ink jet printer that is responsive to digital data signals;
B) loading said printer with an ink jet recording element comprising a substrate that is either a porous or a non-absorbing substrate;
C) loading said printer with an ink jet ink composition comprising an aqueous carrier medium, a surfactant, a pigment and a polymer, wherein the polymer contains benzyl methacrylate and is not associated with the pigment particles; and
D) printing on said ink jet recording element using said ink jet ink composition in response to said digital data signals.

21. The method of method claim 19 wherein the non-absorbing substrate is uncoated vinyl.

22. The method of claim 19 further comprising a heating step during and/or after printing.
